(19) United States
(12) Patent Application Publication
(10) Pub. No.: US 2025/0381684 A1
(43) Pub. Date: Dec. 18, 2025

(54) ROBOT, BATTERY SWAP SYSTEM, AND METHOD OF CONTROLLING ROBOT

(71) Applicants: Hyundai Motor Company, Seoul (KR); Kia Corporation, Seoul (KR)

(72) Inventors: Ji Min Hong, Hwaseong-si (KR); Won Hee Kim, Hwaseong-si (KR)

(21) Appl. No.: 18/944,675

(22) Filed: Nov. 12, 2024

(30) Foreign Application Priority Data
Jun. 12, 2024 (KR) 10-2024-0076565

(51) Int. Cl. B25J 19/00; B25J 9/16

(52) U.S. Cl. CPC B25J 19/005; B25J 9/1661

(57) ABSTRACT

A robot can be configured to receive electric power from a main battery provided replaceably. The robot can include a body having an accommodation space in which the main battery is accommodated in a withdrawable manner, a movement part configured to move the body, and a locking part configured to move relative to the body between a withdrawal-allowed state in which the main battery accommodated in the accommodation space is allowed to be withdrawn from the accommodation space and a withdrawal-inhibited state in which the main battery accommodated in the accommodation space is inhibited from being withdrawn from the accommodation space.

### CROSS-REFERENCE TO RELATED APPLICATIONS

This application claims priority to and the benefit of Korean Patent Application No. 10-2024-0076565 filed in the Korean Intellectual Property Office on June 12, 2024, the entire contents of which are incorporated herein by reference.

### TECHNICAL FIELD

The present disclosure relates to a robot, a battery swap system, and a method of controlling the robot.

### BACKGROUND

In general, a mobile robot is equipped with a battery for storing energy required to operate the robot. When a state of charge of the battery is lower than a predetermined level, the battery is charged by an external charging station. Meanwhile, in a case that the battery is charged by the external charging station, a large amount of time is required to fully charge the battery. For this reason, the robot cannot be used while the battery is charged.

Therefore, recently, there has been an increasing trend of research on a battery swap technology capable of replacing the existing battery provided in the robot with a pre-prepared, fully charged battery in a case that a state of charge of the battery of the robot becomes lower than a predetermined level.

### SUMMARY

An embodiment of the present disclosure can provide a robot capable of efficiently replacing the existing battery with a fully charged battery by use of a motion of the robot.

To achieve the above-mentioned advantages, an embodiment of the present disclosure provides a robot, which can be configured to receive electric power from a main battery provided replaceably, the robot can include: a body having an accommodation space in which the main battery is accommodated in a withdrawable manner; a movement part configured to move the body; and a locking part configured to move relative to the body between a withdrawal-allowed state in which the main battery accommodated in the accommodation space is allowed to be withdrawn from the accommodation space and a withdrawal-inhibited state in which the main battery accommodated in the accommodation space is inhibited from being withdrawn from the accommodation space.

The robot may further include: a controller configured to control the movement part and the locking part, in which when a direction in which the main battery is withdrawn from the accommodation space is a withdrawal direction, the locking part does not overlap the accommodation space in the withdrawal-allowed state and at least a part of the locking part overlaps the accommodation space in the withdrawal-inhibited state when a side of the body based on the withdrawal direction is viewed in parallel with the withdrawal direction, and in which when a state of charge of the main battery accommodated in the accommodation space is a predetermined level or lower, the controller controls the movement part so that the body moves in the withdrawal direction and is placed in a first posture, and then the controller controls the locking part so that the locking part is placed in the withdrawal-allowed state.

The robot may further include: a sub-battery configured to supply electric power to the robot, in which when the state of charge of the main battery accommodated in the accommodation space is the predetermined level or lower, the controller changes an electric power supply source of the robot from the main battery to the sub-battery and then controls the movement part so that the body is placed in the first posture.

The robot may further include: an accommodation detection sensor configured to detect whether the main battery is accommodated in the accommodation space, in which when it is detected that the main battery is accommodated in the accommodation space in the state in which the body is placed in the first posture, the controller controls the locking part so that the locking part is placed in the withdrawal-inhibited state.

The robot may further include: a docking detection sensor configured to detect whether the robot is docked with a first station region including a first battery slot in which a first battery, which is the main battery having a state of charge that is the predetermined level or lower, is accommodated, in which when it is detected that the robot is docked with the first station region, the controller controls the locking part so that the locking part is placed in the withdrawal-allowed state so that the first battery accommodated in the accommodation space is withdrawn to the first battery slot, and then the controller controls the movement part so that the body moves from the first posture in a direction opposite to the withdrawal direction and is placed in a second posture.

The robot may further include: an accommodation detection sensor configured to detect whether the main battery is accommodated in the accommodation space, in which the docking detection sensor further detects whether the robot is docked with a second station region including a second battery slot in which a second battery, which is the main battery having a state of charge that exceeds the predetermined level, is accommodated, in which when it is detected that the robot is docked with the second station region, the controller controls the locking part so that the locking part is placed in the withdrawal-allowed state so that the second battery accommodated in the second battery slot is allowed to be accommodated in the accommodation space, and in which when it is detected that the second battery is accommodated in the accommodation space, the controller controls the locking part so that the locking part switches from the withdrawal-allowed state to the withdrawal-inhibited state.

An embodiment of the present disclosure can provide a method of controlling the robot, the method can include: a state-of-charge determining step of determining a state of charge of the main battery is the predetermined level or lower; a first posture controlling step of controlling the movement part so that the movement part is placed in a first posture; and a withdrawal allowing step of controlling the locking part so that the locking part is placed in the withdrawal-allowed state.

The method may further include an electric power supply source changing step of changing an electric power supply source of the robot from the main battery to a sub-battery provided in the robot when it is determined that the state of charge of the main battery is the predetermined level or lower in the state-of-charge determining step, in which the first posture controlling step is performed after the electric power supply source changing step.

The method may further include an accommodation detecting step of detecting whether the main battery is accommodated in the accommodation space; and a withdrawal inhibiting step of controlling the locking part so that the locking part is placed in the withdrawal-inhibited state when it is detected that the main battery is accommodated in the accommodation space in the accommodation detecting step.

The method may further include: a first docking detecting step of detecting whether the robot is docked with a first station region having a first battery slot in which a first battery, which is the main battery having a state of charge that is the predetermined level or lower, is accommodated; and a second posture controlling step of allowing the body to move from the first posture in a direction opposite to a withdrawal direction and be positioned in a second posture when a direction in which the main battery is withdrawn from the accommodation space is the withdrawal direction, in which when it is detected that the robot is docked with the first station region in the first docking detecting step, the second posture controlling step is performed after the withdrawal allowing step is performed.

The method may further include: an accommodation detecting step of detecting whether the main battery is accommodated in the accommodation space; a second docking detecting step of detecting whether the robot is docked with a second station region having a second battery slot in which a second battery, which is the main battery having a state of charge that exceeds the predetermined level, is accommodated; and a withdrawal inhibiting step of switching the locking part from the withdrawal-allowed state to the withdrawal-inhibited state when it is detected that the second battery is accommodated in the accommodation space in the accommodation detecting step after the withdrawal allowing step is performed when it is detected that the robot is docked with the second station region in the second docking detecting step.

An embodiment of the present disclosure can provide a battery swap system including: a robot; and a charging station configured to charge the main battery, in which the charging station includes a battery slot configured to accommodate the main battery, a lift platform configured to raise or lower the main battery accommodated in the battery slot, and a docking region configured to be docked with the robot, and in which the lift platform is configured to raise or lower the main battery on the basis of whether the robot and the docking region are docked.

The lift platform may include a seating surface on which the main battery is seated, the seating surface may be configured to be raised when the robot and the docking region are docked with each other, and the seating surface may be configured to be lowered when the robot and the docking region are undocked.

A robot according to an embodiment of the present disclosure may efficiently replace an existing battery with a fully charged battery.

### BRIEF DESCRIPTION OF THE DRAWINGS

FIG. 1 is a view illustrating a state in which a robot according to an embodiment of the present disclosure is placed in a standing posture.

FIG. 2 is a view illustrating a state in which the robot according to an embodiment of the present disclosure is placed in a sitting posture.

FIG. 3 is a view illustrating a state of a station region according to one example when the robot according to an embodiment of the present disclosure is docked with a docking region.

FIG. 4 is a view illustrating a state of the station region according to one example when the robot according to an embodiment of the present disclosure is undocked from the docking region.

FIG. 5 is a view illustrating a state in which a motor of a lift platform according to an example moves a main battery upward when the robot according to an embodiment of the present disclosure is docked with the docking region.

FIG. 6 is a view conceptually illustrating a battery swap system according to an embodiment of the present disclosure.

### DETAILED DESCRIPTION OF ILLUSTRATIVE EMBODIMENTS

Hereinafter, some example embodiments of the present disclosure will be described in detail with reference to the illustrative drawings. In giving reference numerals to constituent elements of the respective drawings, it can be noted that same constituent elements can be designated by same reference numerals, if possible, even though the constituent elements are illustrated in different drawings. In the following description of the example embodiments of the present disclosure, a detailed description of related publicly-known configurations or functions can be omitted when it is determined that the detailed description can obscure the understanding of the embodiments of the present disclosure.

Hereinafter, a robot 10 and a battery swap system including the same according to example embodiments of the present disclosure will be described with reference to the drawings.

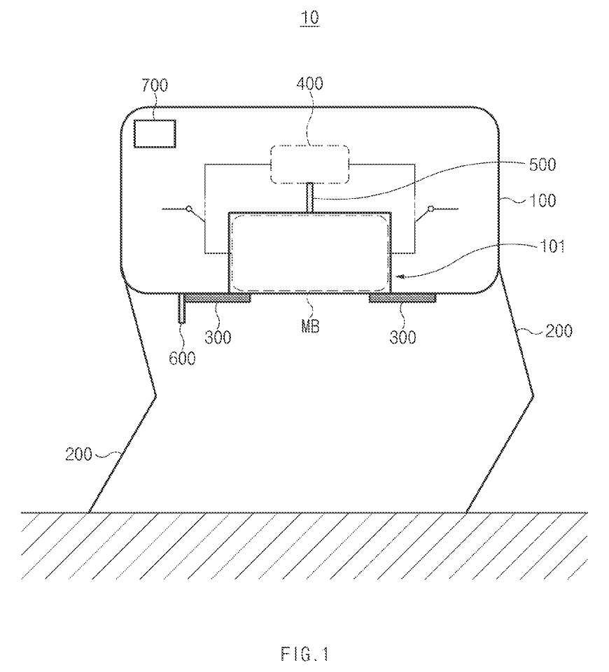

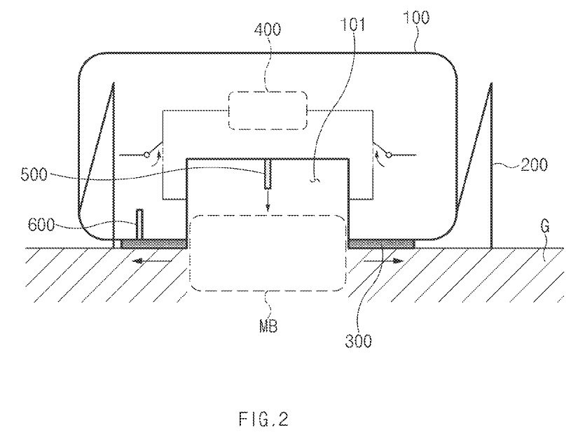

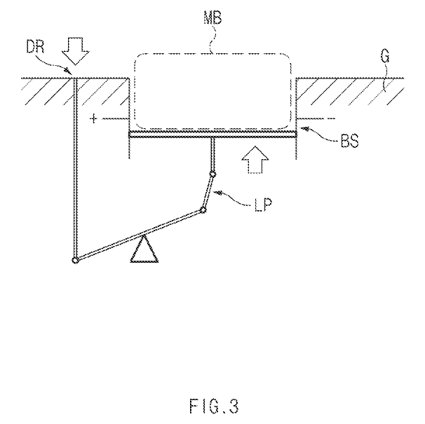

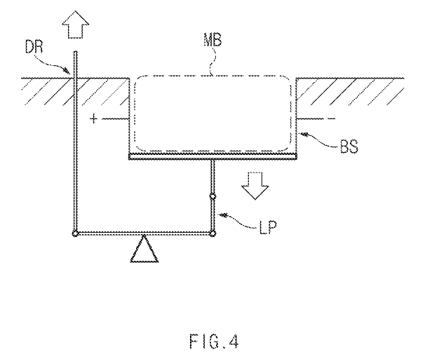

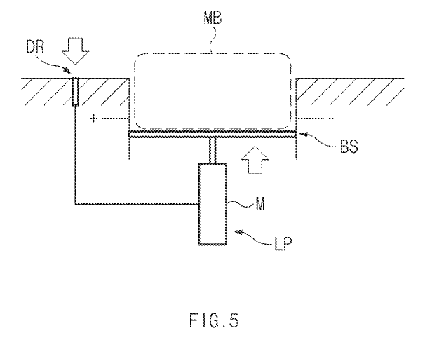

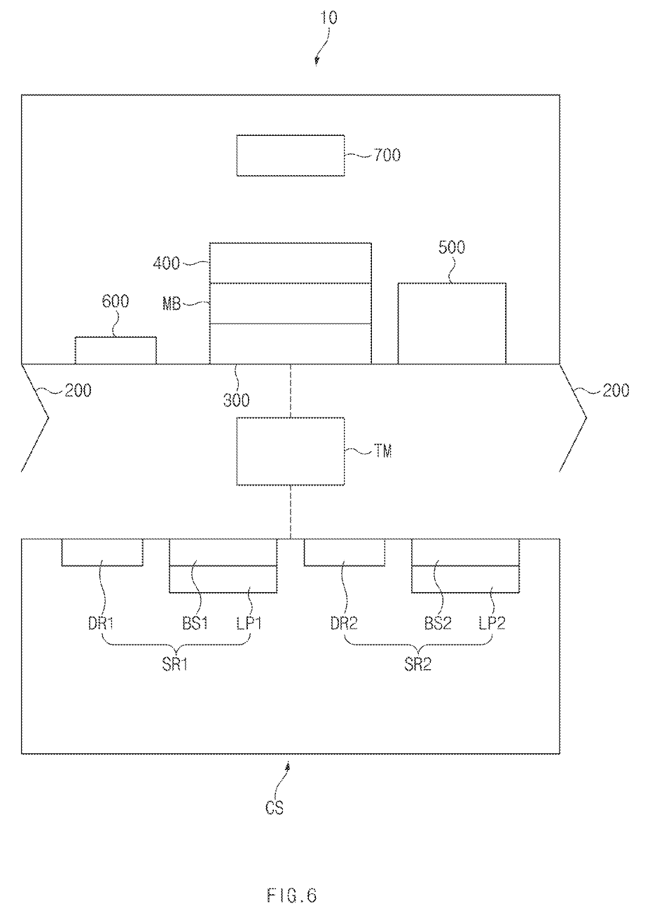

FIG. 1 is a view illustrating a state in which a robot according to an embodiment of the present disclosure is placed in a standing posture. FIG. 2 is a view illustrating a state in which a robot according to an embodiment of the present disclosure is placed in a sitting posture. FIG. 3 is a view illustrating a state of a station region according to one example when a robot according to an embodiment of the present disclosure is docked with a docking region. FIG. 4 is a view illustrating a state of a station region according to one example when a robot according to an embodiment of the present disclosure is undocked from a docking region. FIG. 5 is a view illustrating a state in which a motor of a lift platform according to an example moves a main battery upward when a robot according to an embodiment of the present disclosure is docked with a docking region. FIG. 6 is a view conceptually illustrating a battery swap system according to an embodiment of the present disclosure. With reference to FIGS. 1 to 6, a battery swap system may include a robot 10, a charging station CS, and a task manager TM.

The robot 10 may be provided as a mobile robot configured to travel on the ground surface, or a drone configured to fly in the air. The robot 10 may be configured to replace the existing main battery MB with a fully charged main battery MB. For example, the robot 10 may replace the main battery MB by being docked with the charging station CS.

The robot 10 and the charging station CS may communicate with each other in a wired and/or wireless manner through the task manager TM. For example, the task manager TM may be configured to receive signals from the robot 10 and the charging station CS or transmit signals to the robot 10 and the charging station CS.

With reference to FIG. 6, the charging station CS may have a station region that may be docked with the robot 10. The station region may include a docking region DR, a lift platform LP, and a battery slot BS.

With reference back to FIGS. 3 and 4, the docking region DR may refer to a region that may be docked with the robot 10. For example, in a case that the robot 10 is docked with the docking region DR, an accommodation space 101 and the battery slot BS may be kept aligned with each other. In a case that the accommodation space 101 and the battery slot BS are kept aligned with each other, the main battery MB may be allowed to move between the accommodation space 101 and the battery slot BS without interference.

The lift platform LP may provide a seating surface on which the main battery MB may be seated. The lift platform LP may raise or lower the main battery MB seated on the seating surface. For example, the seating surface of the lift platform LP may move upward or downward while corresponding to a motion of the docking region DR. In a detailed example, when the robot 10 presses the docking region DR and moves the docking region DR downward relative to the ground surface, the seating surface of the lift platform LP may be moved upward relative to the ground surface. When the docking region DR is released and the docking region DR moves upward relative to the ground surface, the seating surface of the lift platform LP may be moved downward relative to the ground surface.

For example, the lift platform LP may have a lever structure including a docking part, a lifting part, and a support. The docking part may move in an upward/downward direction so that the docking part protrudes upward from the docking region DR or is retracted into a ground surface G. The lifting part may move the seating surface upward when the docking part is pressed downward and retracted into the ground surface G. The support may support one point positioned between the docking part and the lifting part. Assuming that one point supported by the support is a support point, the docking part and the lifting part may move upward or downward in opposite directions based on the support point.

With reference to FIG. 5, the lift platform LP, as another example, may include a docking part and a motor M. For example, when the docking part is moved downward by the robot 10, the motor M may move the seating surface upward. The docking part and the motor M may be electrically connected. The motor M may be an actuator that may move the seating surface upward or downward.

The station region may be provided as a plurality of station regions. The plurality of station regions may include a first station region SR1 and a second station region SR2. The first station region SR1 and the second station region SR2 may be disposed at different positions. A fully charged main battery MB may be provided in the first station region SR1, and the existing main battery MB, which has been provided in the robot 10 and used, may be accommodated in the second station region SR2.

The docking region, the lift platform, and the battery slot of the first station region SR1 may be respectively referred to as a first docking region DR1, a first lift platform LP1, and a first battery slot BS1. The docking region, the lift platform, and the battery slot of the second station region SR2 may be respectively referred to as a second docking region DR2, a second lift platform LP2, and a second battery slot BS2.

With reference back to FIGS. 1 and 2, the robot 10 may include a body 100, movement parts 200, locking parts 300, a sub-battery 400, an accommodation detection sensor 500, a docking detection sensor 600, and a controller 700, any of, any combination of, or all of which may be in plural or may include plural components thereof.

The body 100 may be supported by the movement part 200. The body 100 may support the locking part 300, the sub-battery 400, the accommodation detection sensor 500, and the docking detection sensor 600. The accommodation space 101 may be formed in the body 100.

The main battery MB may be separably accommodated in the accommodation space 101. The accommodation space 101 may be formed at a lower side of the body 100. For example, the accommodation space 101 may have a shape opened downward. In other words, the accommodation space 101 may have a shape recessed upward from a lower end of the body 100.

The movement parts 200 may move the body 100. For example, the movement parts 200 may be provided as a plurality of legs. Furthermore, the plurality of legs may each have one or more joints. The movement parts 200 may be connected to a lower portion of the body 100. The movement parts 200 may move the body 100 in the horizontal direction and the upward/downward direction.

The movement parts 200 may determine a posture of the body 100. For example, the body 100 may be placed in a sitting posture (see FIG. 2) or a standing posture (see FIG. 1) by use of the movement parts 200. In the present specification, the sitting posture may be referred to as a first posture, and the standing posture may be referred to as a second posture.

For example, in a case that the movement parts 200 lower the body 100 placed in the second posture, the body 100 may switch from the second posture to the first posture. When the body 100 is in the first posture, the accommodation space 101 may be tightly attached to the ground surface G based on the upward/downward direction.

In a case that the movement parts 200 raise the body 100 placed in the sitting posture, the body 100 may switch from the first posture to the second posture. When the body 100 is in the second posture, the accommodation space 101 may be spaced apart from the ground surface G in the upward/downward direction. The movement part 200 may be controlled by the controller 700.

The locking part 300 may allow the main battery MB to be withdrawn from the accommodation space 101 or inhibit the main battery MB from being withdrawn from the accommodation space 101. The locking parts 300 may move relative to the body 100 between a withdrawal-allowed state and a withdrawal-inhibited state.

When the locking part 300 is in the withdrawal-allowed state, the main battery MB accommodated in the accommodation space 101 may be allowed to be withdrawn from the accommodation space 101. For example, when the locking part 300 is in the withdrawal-allowed state, the accommodation space 101 may be opened downward. In a detailed example, when a side of the body 100 based on a withdrawal direction is viewed in parallel with the withdrawal direction, the locking parts 300 placed in the withdrawal-allowed state may not overlap the accommodation space 101. The withdrawal direction may refer to a direction in which the main battery MB accommodated in the accommodation space 101 is withdrawn from the accommodation space 101. For example, the withdrawal direction may be a downward direction.

When the locking part 300 is in the withdrawal-inhibited state, the main battery MB accommodated in the accommodation space 101 may be inhibited from being withdrawn from the accommodation space 101. For example, when the locking part 300 is in the withdrawal-inhibited state, at least a part of a lower side of the accommodation space 101 may be closed. In a detailed example, when the side of the body 100 based on the withdrawal direction is viewed in parallel with the withdrawal direction, at least a part of the locking part 300 placed in the withdrawal-inhibited state may overlap the accommodation space 101.

The locking parts 300 may be disposed on the lower portion of the body 100. The locking part 300 may move relative to the body 100 to block a lower side of the accommodation space 101 from the outside. For example, the locking part 300 may be configured to slide in the horizontal direction relative to the body 100. The locking part 300 may be controlled by the controller 700. The locking parts 300 may be provided as a plurality of locking parts 300.

The plurality of locking parts 300 may be disposed to be spaced apart from one another in the horizontal direction with a center of the accommodation space 101 interposed therebetween. The plurality of locking parts 300 may move toward or away from one another relative to the body 100. For example, the plurality of locking parts 300 may each have a shutter shape that blocks the lower side of the accommodation space 101 from the outside or allows the lower side of the accommodation space 101 to be opened.

The sub-battery 400 may supply electric power to the robot 10. For example, the sub-battery 400 may supply electric power to the robot 10 when the robot 10 cannot receive electric power from the main battery MB. In a detailed example, when a state of charge of the main battery MB is a predetermined level or lower, an electric power supply source of the robot 10 may be changed from the main battery MB to the sub-battery 400. In other words, the robot 10 may receive electric power from any one of the sub-battery 400 and the main battery MB. The predetermined level may be a level inputted in advance to the controller 700 or a variable level that may be inputted from the outside.

The sub-battery 400 can supply electric power to the robot 10 while the main battery MB is replaced, which may prevent the supply of electric power to the robot 10 from being temporarily cut off. Therefore, the hot swap is enabled because a state in which the robot 10 is not turned off is maintained while the battery is replaced. The sub-battery 400 may be mounted in the body 100. The sub-battery 400 may be disposed above the accommodation space 101.

The accommodation detection sensor 500 may detect whether the main battery MB is accommodated in the accommodation space 101. For example, the accommodation detection sensor 500 may transmit an accommodation signal to the controller 700 when the main battery MB is accommodated in the accommodation space 101. The accommodation detection sensor 500 may transmit a withdrawal signal to the controller 700 when the main battery MB is withdrawn from the accommodation space 101. The accommodation detection sensor 500 may be connected to an upper side of the accommodation space 101.

The docking detection sensor 600 may detect whether the robot 10 is docked with the docking region DR of the station region. For example, the docking detection sensor 600 may detect whether the robot 10 is docked with the first docking region DR1 of the first station region SR1 or the second docking region DR2 of the second station region SR2. The docking detection sensor 600 may be disposed at a lower end of the body 100. The present disclosure is not limited to this example. The docking detection sensor 600 may also be disposed in the docking region DR.

When the docking detection sensor 600 detects that the robot 10 is docked with the docking region DR, the robot 10 and the battery slot BS may be kept aligned with each other. In a case that the robot 10 and the battery slot BS are kept aligned with each other, a horizontal edge of the accommodation space 101 and a horizontal edge of the battery slot BS may correspond to each other.

The controller 700 may control the movement part 200 and the locking part 300. The controller 700 may control the movement part 200 so that the robot 10 moves to the charging station CS when the state of charge of the main battery accommodated in the accommodation space 101 is the predetermined level or lower. The main battery, which has the state of charge that is the predetermined level or lower, may be referred to as a first battery.

Hereinafter, a process of detaching the first battery from the accommodation space 101 will be described.

The controller 700 may control the movement parts 200 so that the accommodation space 101 and the first battery slot BS1 are aligned with each other.

Thereafter, the controller 700 may change the electric power supply source of the robot 10 from the first battery to the sub-battery 400.

Thereafter, the controller 700 may control the movement parts 200 so that the body 100 moves in the withdrawal direction and is placed in the first posture (sitting posture).

Thereafter, the task manager TM may control the first lift platform LP1 so that the seating surface moves upward and approaches the accommodation space 101.

Thereafter, when the docking detection sensor 600 can detect that the robot 10 is docked with the first docking region DR1, the controller 700 may control the locking parts 300 so that the locking parts 300 are placed in the withdrawal-allowed state. In this case, the first battery accommodated in the accommodation space 101 of the body 100 may be seated on the raised seating surface.

Thereafter, the controller 700 may control the movement parts 200 so that the body 100 moves from the first posture in the direction (the upward direction) opposite to the withdrawal direction and is placed in the second posture (standing posture). In this case, the task manager TM may control the first lift platform LP1 so that the first battery seated on the seating surface is lowered and accommodated in the first battery slot BS1. Thereafter, information, which can indicate that the first battery is accommodated in the first battery slot BS1, may be updated in the task manager TM.

Hereinafter, a process of inserting a second battery into the accommodation space 101 will be described.

The controller 700 may control the movement parts 200 so that the accommodation space 101 and the second battery slot BS2 are aligned with each other.

Thereafter, the controller 700 may control the movement parts 200 so that the body 100 moves in the withdrawal direction and is placed in the first posture.

Thereafter, when the docking detection sensor 600 detects that the robot 10 is docked with the second docking region DR2, the controller 700 may control the locking parts 300 so that the locking parts 300 are placed in the withdrawal-allowed state.

Thereafter, the task manager TM may control the second lift platform LP2 so that the seating surface moves upward and approaches the accommodation space 101. In this case, the main battery MB, which can be positioned in the second battery slot BS2 and can have the state of charge that exceeds the predetermined level, may be accommodated in the accommodation space 101. The main battery MB, which can have the state of charge that exceeds the predetermined level, may be referred to as the second battery.

Thereafter, when the accommodation detection sensor 500 detects that the second battery is accommodated in the accommodation space 101, the controller 700 may control the locking parts 300 so that the locking parts 300 switch from the withdrawal-allowed state to the withdrawal-inhibited state.

Thereafter, the controller 700 may change the electric power supply source of the robot 10 from the sub-battery 400 to the second battery. In this case, the sub-battery 400 may be charged by the second battery.

Thereafter, the controller 700 may control the movement parts so that the body 100 switches from the first posture to second posture. In this case, the task manager TM may control the second lift platform LP2 so that the seating surface is lowered and accommodated in the second battery slot BS2. Thereafter, information, which can indicate that the main battery MB is accommodated in the second battery slot BS2, may be updated in the task manager TM.

The controller 700 may be electrically connected to the movement parts 200, the locking parts 300, the sub-battery 400, and the task manager TM and implemented as a process that serves to decode and execute instructions on the basis of inputted information.

Hereinafter, a method of controlling the robot 10 according to an embodiment of the present disclosure will be described.

A method of controlling the robot may include a state-of-charge determining step, an electric power supply source changing step, a first posture controlling step, a first docking detecting step, a withdrawal allowing step, a second posture controlling step, a second docking detecting step, an accommodation detecting step, and a withdrawal inhibiting step.

In the state-of-charge determining step, whether the state of charge of the main battery MB accommodated in the accommodation space 101 is the predetermined level or lower may be determined. When it is determined that the state of charge of the main battery MB is the predetermined level or lower in the state-of-charge determining step, the robot 10 may move to the first station region SR1.

In the electric power supply source changing step, the electric power supply source of the robot 10 may be changed from any one of the main battery MB and the sub-battery 400 to the other of the main battery MB and the sub-battery 400. For example, when it is determined that the state of charge of the main battery MB is the predetermined level or lower in the state-of-charge determining step, the electric power supply source of the robot 10 may be changed from the main battery MB to the sub-battery 400.

As another example, when it is determined that the state of charge of the main battery MB exceeds the predetermined level in the state-of-charge determining step, the electric power supply source of the robot 10 may be changed from the sub-battery 400 to the main battery MB. For example, the electric power supply source changing step may be performed after the state-of-charge determining step. The first posture controlling step may be performed when the electric power supply source of the robot 10 is changed from the sub-battery 400 to the main battery MB in the electric power supply source changing step.

In the first posture controlling step, the body 100 may switch from the second posture to the first posture. The first docking detecting step may be performed when the body 100 switches to the first posture in the first posture controlling step.

In the first docking detecting step, whether the robot 10 is docked with the first docking region DR1 may be detected. The withdrawal allowing step may be performed when it is detected that the robot 10 is docked with the first docking region DR1 in the first docking detecting step.

In the withdrawal allowing step, the locking part 300 may switch from the withdrawal-inhibited state to the withdrawal-allowed state. In a case that the withdrawal allowing step is performed, the first battery may be withdrawn from the accommodation space 101 so that the first battery is accommodated in the first battery slot BS1. The second posture controlling step may be performed after the withdrawal allowing step is performed.

In the second posture controlling step, the body 100 may switch from the first posture to the second posture. After the second posture controlling step is performed, the robot 10 may be controlled to move to the second station region SR2. Thereafter, the first posture controlling step may be performed so that the robot 10 is docked with the second docking region DR2. Thereafter, the second docking detecting step may be performed.

In the second docking detecting step, whether the robot 10 is docked with the second docking region DR2 may be detected. The withdrawal allowing step may be performed when it is detected that the robot 10 is docked with the second docking region DR in the second docking detecting step. Thereafter, the accommodation detecting step may be performed.

In the accommodation detecting step, whether the second battery is accommodated in the accommodation space 101 may be detected. The withdrawal inhibiting step may be performed when it is detected that the second battery is accommodated in the accommodation space 101 in the accommodation detecting step.

In the withdrawal inhibiting step, the locking part 300 may switch from the withdrawal-allowed state to the withdrawal-inhibited state.

All the constituent elements, which constitute an embodiment of the present disclosure, may be integrally coupled or operate by being combined, but the present disclosure is not necessarily limited to the example embodiments. That is, one or more of the constituent elements may be selectively combined and operated within an embodiment of the present disclosure. Unless explicitly described to the contrary, the words "comprise," "include," or "have" and variations such as "comprises," "comprising," "includes," "including," has," or "having," can be understood to imply the inclusion of stated elements but not the exclusion of any other elements. Unless otherwise defined, terms including technical or scientific terms may have a same meaning as commonly understood by those skilled in the art to which the present disclosure pertains. Terms such as those defined in a commonly used dictionary may be interpreted as having meanings consistent with meanings in the context of related technologies.

The above description is simply given for illustratively describing the technical spirit of the present disclosure, and those skilled in the art to which the present disclosure pertains can appreciate that various changes and modifications are possible without departing from the essential characteristic of the present disclosure. Therefore, the example embodiments disclosed in the present disclosure are provided for illustrative purposes and are not intended to necessarily limit the technical spirit of the present disclosure. The scopes of the technical spirit of the present disclosure are not limited thereby. The protective scopes of the present disclosure can be construed based on the following claims, and all the technical spirit in equivalent scopes thereto can be construed as falling within the scope of the present disclosure.

What is claimed is:

1. A robot, wherein the robot is configured to receive electric power from a main battery provided replaceably, the robot comprising:
a body having an accommodation space in which the main battery can be accommodated in a withdrawable manner;
a movement part configured to move the body; and
a locking part configured to move relative to the body between a withdrawal-allowed state in which the main battery accommodated in the accommodation space is allowed to be withdrawn from the accommodation space and a withdrawal-inhibited state in which the main battery accommodated in the accommodation space is inhibited from being withdrawn from the accommodation space.

2. The robot of claim 1, further comprising a controller configured to control the movement part and the locking part,
wherein a direction in which the main battery is withdrawn from the accommodation space is a withdrawal direction, wherein the locking part is configured such that the locking part does not overlap the accommodation space in the withdrawal-allowed state, and wherein the locking part is configured such that at least a part of the locking part overlaps the accommodation space in the withdrawal-inhibited state with respect to a side of the body as viewed in parallel with the withdrawal direction, and
wherein in response to a state of charge of the main battery accommodated in the accommodation space being a predetermined level or lower, the controller is configured to control the movement part so that the body moves in the withdrawal direction and is placed in a first posture, and then the controller controls the locking part so that the locking part is placed in the withdrawal-allowed state.

3. The robot of claim 2, further comprising a sub-battery configured to supply electric power to the robot, wherein in response to the state of charge of the main battery accommodated in the accommodation space being the predetermined level or lower, the controller is configured to change an electric power supply source of the robot from the main battery to the sub-battery and then control the movement part so that the body is placed in the first posture.

4. The robot of claim 2, further comprising an accommodation detection sensor configured to detect whether the main battery is accommodated in the accommodation space, wherein in response to accommodation detection sensor detecting that the main battery is accommodated in the accommodation space in the state in which the body is placed in the first posture, the controller is configured to control the locking part so that the locking part is placed in the withdrawal-inhibited state.

5. The robot of claim 2,. comprising a docking detection sensor configured to detect whether the robot is docked with a first station region including a first battery slot in which a first battery, which is the main battery having a state of charge that is the predetermined level or lower, is accommodated, wherein in response to the docking detection sensor detecting that the robot is docked with the first station region, the controller is configured to control the locking part so that the locking part is placed in the withdrawal-allowed state so that the first battery accommodated in the accommodation space can be withdrawn to the first battery slot, and then the controller controls the movement part so that the body moves from the first posture in a second direction opposite to the withdrawal direction and is placed in a second posture.

6. The robot of claim 5, further comprising an accommodation detection sensor configured to detect whether the main battery is accommodated in the accommodation space,
wherein the docking detection sensor further configured to detect whether the robot is docked with a second station region including a second battery slot in which a second battery, which is another main battery having a state of charge that exceeds the predetermined level, is accommodated,
wherein in response to the docking detection sensor detecting that the robot is docked with the second station region, the controller is configured to control the locking part so that the locking part is placed in the withdrawal-allowed state so that the second battery accommodated in the second battery slot is allowed to be accommodated in the accommodation space, and
wherein in response to the accommodation detection sensor detecting that the second battery is accommodated in the accommodation space, the controller is configured to control the locking part so that the locking part switches from the withdrawal-allowed state to the withdrawal-inhibited state.

7. The robot of claim 1, further comprising a controller configured to control the movement part and the locking part, wherein the controller is further configured to:
determine whether a state of charge of the main battery is a predetermined level or lower;
control the movement part so that the movement part is placed in a first posture; and
control the locking part so that the locking part is placed in the withdrawal-allowed state.

8. The robot of claim 7, wherein the controller is further configured to:
change an electric power supply source of the robot from the main battery to a sub-battery provided in the robot in response to determining that the state of charge of the main battery is the predetermined level or lower,
wherein the control of the movement part to be placed in the first posture is performed after the change of the electric power supply source to the sub-battery.

9. The robot of claim 7, wherein the controller is further configured to:
detect whether the main battery is accommodated in the accommodation space; and
control the locking part so that the locking part is placed in the withdrawal-inhibited state in response to detecting that the main battery is accommodated in the accommodation space.

10. The robot of claim 7, wherein the controller is further configured to:
after the control of the locking part so that the locking part is placed in the withdrawal-allowed state, detect whether the robot is docked with a first station region having a first battery slot in which a first battery, which is the main battery having a state of charge that is the predetermined level or lower, is accommodated; and
in response to detecting that the robot is docked with the first station region, controlling the moving part to move the body from the first posture in a second direction opposite to a withdrawal direction and be positioned in a second posture, wherein a direction in which the main battery is withdrawn from the accommodation space is the withdrawal direction.

11. The robot of claim 10, wherein the controller is further configured to:
detect whether the main battery is accommodated in the accommodation space;
detecting whether the robot is docked with a second station region having a second battery slot in which a second battery, which is another main battery having a state of charge that exceeds the predetermined level, is accommodated; and
after the control of the locking part so that the locking part is placed in the withdrawal-allowed state, and after detecting that the robot is docked with the second station region, switch the locking part from the withdrawal-allowed state to the withdrawal-inhibited state in response to detecting that the second battery is accommodated in the accommodation space.

12. A battery swap system comprising:
a robot configured to receive electric power from a main battery provided replaceably, wherein the robot comprises:
a body having an accommodation space in which the main battery can be accommodated in a withdrawable manner,
a movement part configured to move the body, and
a locking part configured to move relative to the body between a withdrawal-allowed state in which the main battery accommodated in the accommodation space is allowed to be withdrawn from the accommodation space and a withdrawal-inhibited state in which the main battery accommodated in the accommodation space is inhibited from being withdrawn from the accommodation space; and
a charging station configured to charge the main battery, wherein the charging station comprises:
a battery slot configured to accommodate the main battery,
a lift platform configured to raise or lower the main battery accommodated in the battery slot, and
a docking region configured to be docked with the robot, wherein the lift platform is configured to raise or lower the main battery based on whether the robot and the docking region are docked with each other.

13. The battery swap system of claim 12, wherein the lift platform comprises a seating surface on which the main battery is seated, and wherein the seating surface is configured to be raised in response to the robot and the docking region being docked with each other, and the seating surface is configured to be lowered in response to the robot and the docking region being undocked.

14. A method of controlling a robot, the method comprising:
determining whether a state of charge of a main battery of the robot is at a predetermined level or lower, wherein the robot is configured to receive electric power from the main battery, and wherein the main battery is replaceably provided in an accommodation space of a body of the robot in which the main battery can be accommodated in a withdrawable manner;
in response to the state of charge of the main battery being at the predetermined level or lower, controlling a movement part of the robot so that the movement part is placed in a first posture, wherein the movement part is configured to move the body of the robot; and
in response to controlling the movement part toward the first posture, controlling a locking part so that the locking part is placed in a withdrawal-allowed state, wherein the locking part is configured to move relative to the body between the withdrawal-allowed state in which the main battery accommodated in the accommodation space is allowed to be withdrawn from the accommodation space and a withdrawal-inhibited state in which the main battery accommodated in the accommodation space is inhibited from being withdrawn from the accommodation space.

15. The method of claim 14, further comprising changing an electric power supply source of the robot from the main battery to a sub-battery provided in the robot in response to determining that the state of charge of the main battery is the predetermined level or lower, and wherein the controlling of the movement part of the robot to the first posture is performed after the changing of the electric power supply source of the robot from the main battery to the sub-battery.

16. The method of claim 14, further comprising:
detecting whether the main battery is accommodated in the accommodation space; and
controlling the locking part so that the locking part is placed in the withdrawal-inhibited state in response to detecting that the main battery is accommodated in the accommodation space.

17. The method of claim 14, further comprising:
detecting whether the robot is docked with a first station region having a first battery slot in which a first battery, which is the main battery having a state of charge that is the predetermined level or lower, is accommodated; and
after the controlling of the locking part so that the locking part is placed in the withdrawal-allowed state, and in response to detecting that the robot is docked with the first station region, controlling the body to move from the first posture in a second direction opposite to a withdrawal direction and be positioned in a second posture, wherein a direction in which the main battery is withdrawn from the accommodation space is the withdrawal direction.

18. The method of claim 17, further comprising:
detecting whether the main battery is accommodated in the accommodation space;
detecting whether the robot is docked with a second station region having a second battery slot in which a second battery is accommodated, wherein the second battery is another main battery having a state of charge that exceeds the predetermined level; and
switching the locking part from the withdrawal-allowed state to the withdrawal-inhibited state in response to detecting that the second battery is accommodated in the accommodation space after controlling the locking part so that the locking part is placed in the withdrawal-allowed state in response to detecting that that the robot is docked with the second station region.
